(19) United States
(12) Patent Application Publication
(10) Pub. No.: US 2022/0158553 A1
(43) Pub. Date: May 19, 2022

(54) DC-DC CONVERTER

(71) Applicant: KABUSHIKI KAISHA YASKAWA DENKI, Kitakyushu-shi (JP)

(72) Inventors: Tadashi SADOHARA, Fukuoka (JP); Masakazu MIYAMOTO, Fukuoka (JP)

(21) Appl. No.: 17/665,590

(22) Filed: Feb. 7, 2022

Related U.S. Application Data
(63) Continuation of application No. PCT/JP2019/031731, filed on Aug. 9, 2019.

(51) Int. Cl. H02M 3/156; H02M 1/08; H02M 3/07

(52) U.S. Cl. CPC H02M 3/156; H02M 3/07; H02M 1/08

(57) ABSTRACT

The DC-DC converter may be configured to perform DC-DC power conversion between a primary side and a secondary side. The DC-DC converter may include: a reactor; a switching element configured to switch between an on period for accumulating a first energy in the reactor from the primary side and an off period for releasing the first energy from the reactor to the secondary side, causing a switch voltage acting on the switching element to rise during the off period; a first capacitor; and a second capacitor. The second capacitor may be configured to: accumulate a charge provided from the primary side during the off period; and transfer the charge to the first capacitor during the on period. The first capacitor may be configured to suppress, using the charge transferred from the second capacitor, the rise of the switch voltage after the switching element is switched back to the off period.

### CROSS-REFERENCE TO RELATED APPLICATIONS

This application is a continuation application of PCT Application No. PCT/JP2019/031731 filed on Aug. 9, 2019, the entire contents of which are incorporated herein by reference.

### BACKGROUND

### Field

International Publication No. WO/2015/079538 discloses a DC-DC converter including a boost chopper circuit that has an input terminal connected to a DC power supply, an output terminal connected to a load, a reactor placed between the input terminal and the output terminal, a blocking diode connected in series with the reactor, and a switching element having one end connected between the reactor and the blocking diode, and generates an output voltage by boosting an input voltage. The DC-DC converter further includes a first reactor placed between the input terminal and one end of the switching element, a first capacitor disposed between the first reactor and the switching element and connected in series with the first reactor, and a first diode having an anode terminal connected to a connection portion of the first reactor and the first capacitor and a cathode terminal connected to the output terminal.

### SUMMARY

Disclosed herein is a DC-DC converter. The DC-DC converter may be configured to perform DC-DC power conversion between a primary side and a secondary side. The DC-DC converter may include: a reactor; a switching element configured to switch between an on period for accumulating a first energy in the reactor from the primary side and an off period for releasing the first energy from the reactor to the secondary side, causing a switch voltage acting on the switching element to rise during the off period; a first capacitor electrically connected to the switching element; and a second capacitor electrically connected to the first capacitor. The second capacitor may be configured to: accumulate a charge provided from the primary side during the off period; and transfer the charge to the first capacitor during the on period. The first capacitor may be configured to suppress, using the charge transferred from the second capacitor, the rise of the switch voltage after the switching element is switched back to the off period.

### BRIEF DESCRIPTION OF THE DRAWINGS

FIG. 1 is a schematic diagram schematically illustrating an example configuration of a DC-DC converter.

FIG. 2 is a diagram illustrating a state of the DC-DC converter before a switching element is switched from off to on.

FIG. 3 is a diagram illustrating the state of the DC-DC converter after the switching element is switched from off to on.

FIG. 4 is a diagram illustrating the state of the DC-DC converter before the switching element is switched from on to off.

FIG. 5 is a diagram illustrating the state of the DC-DC converter after the switching element is switched from on to off.

FIG. 6 is a diagram illustrating the state of the DC-DC converter after the potential of one end of the switching element increases.

FIG. 7 is a schematic diagram illustrating an example modification of the DC-DC converter.

### DETAILED DESCRIPTION

In the following description, with reference to the drawings, the same reference numbers are assigned to the same components or to similar components having the same function, and overlapping description is omitted.

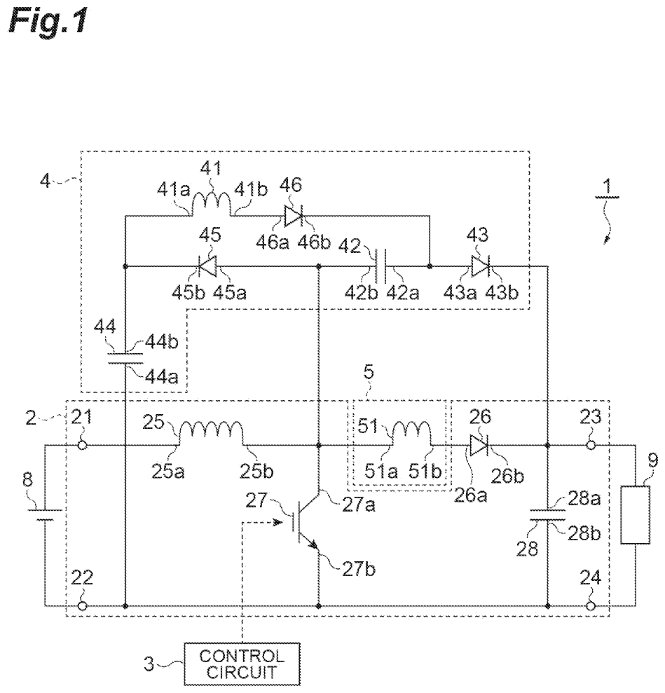

A DC-DC converter 1 illustrated in FIG. 1 is a power conversion device that converts a DC input voltage from a DC power supply 8 into a DC output voltage to a load 9. The DC-DC converter 1 includes a boost chopper circuit 2, a control circuit 3, a ZVS circuit 4, and a ZCS circuit 5.

The boost chopper circuit 2 boosts the input voltage to generate the output voltage. The boost chopper circuit 2 includes a positive input terminal 21, a negative input terminal 22, a positive output terminal 23, a negative output terminal 24, a reactor 25, a blocking diode 26, a switching element 27, and a smoothing capacitor 28.

The positive input terminal 21 and the negative input terminal 22 are connected to a positive electrode and a negative electrode of the DC power supply 8, respectively. The positive output terminal 23 and the negative output terminal 24 are connected to a positive electrode and a negative electrode of the load 9, respectively. The negative input terminal 22 and the negative output terminal 24 are connected to each other by a common line and have substantially the same potential. The term “connection” herein represents electrical connection. The same applies to the following description.

The reactor 25 is located (electrically connected) between the positive electrode of the DC power supply 8 and the positive electrode of the load 9. For example, one end 25a of the reactor 25 is connected to the positive input terminal 21, and another end 25b of the reactor 25 is connected to the positive output terminal 23. The term “connection” herein also includes connection via another conductive electronic component. The same applies to the following description.

The blocking diode 26 is located between the reactor 25 and the positive electrode of the load 9, allows current to flow from the reactor 25 to the load 9, and blocks current from the load 9 to the reactor 25. For example, an anode terminal 26a of the blocking diode 26 is connected to the other end 25b of the reactor 25, and a cathode terminal 26b of the blocking diode 26 is connected to the positive output terminal 23. That is, the other end 25b of the reactor 25 is connected to the positive output terminal 23 via the blocking diode 26.

The switching element 27 switches on and off between the other end 25b of the reactor 25 and the negative electrode of the DC power supply 8. For example, one end 27a of the switching element 27 is connected between the other end 25b of the reactor 25 and the anode terminal 26a of the blocking diode 26, and another end 27b of the switching element 27 is connected to the negative input terminal 22. Examples of the switching element 27 include a bipolar transistor and a metal-oxide-semiconductor field-effect transistor (MOSFET). When the switching element 27 is a bipolar transistor, the one end 27a is a collector terminal, and the other end 27b is an emitter terminal. A control signal for switching on and off the switching element 27 is input to the base terminal of the switching element 27.

The smoothing capacitor 28 smoothes the output voltage. For example, one end 28a of the smoothing capacitor 28 is connected between the cathode terminal 26b of the blocking diode 26 and the positive output terminal 23, and another end 28b of the smoothing capacitor 28 is connected to the negative output terminal 24.

The control circuit 3 outputs the control signal to the switching element 27 (for example, to the base of the switching element 27), thereby switching on and off the switching element 27 at a predetermined switching cycle. When the switching element 27 is on, energy is stored in the reactor 25. When the switching element 27 is switched from on to off, the energy stored in the energy of the reactor 25 is stored in the smoothing capacitor 28 via the blocking diode 26. As a result, the output voltage (the potential difference between the positive output terminal 23 and the negative output terminal 24) is boosted. The control circuit 3 adjusts the output voltage by changing the ratio of the on period and the off period of the switching element 27 in each switching cycle within a predetermined range.

A ZVS circuit 4 is a circuit that makes a transition of the switching element 27 from on to off to be soft switching. For example, the ZVS circuit 4 prevents increase of voltage across the switching element 27 (the potential difference between the one end 27a and the other end 27b) immediately after the switching element 27 is switched from on to off. As an example, the ZVS circuit 4 makes the transition of the switching element 27 from on to off to be zero voltage switching (ZVS). The term “ZVS” represents switching in which the voltage across the switching element 27 is substantially zero immediately after the switching element 27 is switched from on to off.

The ZVS circuit 4 includes a first reactor 41 (an additional reactor), a first capacitor 42, a first diode 43, a second capacitor 44, and a second diode 45.

The first reactor 41 is located between the DC power supply 8 and the one end 27a of the switching element 27. For example, the first reactor 41 is located between the negative electrode of the DC power supply 8 and the one end 27a of the switching element 27. As an example, one end 41a of the first reactor 41 is connected to the negative input terminal 22, and another end 41b of the first reactor 41 is connected to the one end 27a of the switching element 27.

The first capacitor 42 is located between the first reactor 41 and the one end 27a of the switching element 27. For example, one end 42a of the first capacitor 42 is connected to the other end 41b of the first reactor 41, and another end 42b of the first capacitor 42 is connected to the one end 27a of the switching element 27. That is, the other end 41b of the first reactor 41 is connected to the one end 27a of the switching element 27 via the first capacitor 42.

The first diode 43 is located between the first reactor 41 and the positive electrode of the load 9, allows current to flow from the first reactor 41 to the load 9, and blocks current from the load 9 to the first diode 43. For example, an anode terminal 43a of the first diode 43 is connected to an electric path between the other end 41b of the first reactor 41 and the one end 42a of the first capacitor 42, and a cathode terminal 43b of the first diode 43 is connected to an electric path between the cathode terminal 26b of the blocking diode 26 and the positive output terminal 23.

The second capacitor 44 is located between the DC power supply 8 and the first reactor 41. For example, the second capacitor 44 is located between the negative electrode of the DC power supply 8 and the first reactor 41. As an example, one end 44a of the second capacitor 44 is connected to the negative input terminal 22, and another end 44b of the second capacitor 44 is connected to the one end 41a of the first reactor 41. That is, the one end 41a of the first reactor 41 is connected to the negative input terminal 22 via the second capacitor 44.

The second diode 45 is located between the other end 44b of the second capacitor 44 and the one end 27a of the switching element 27, allows current to flow from the one end 27a to the other end 44b, and blocks the current from the other end 44b to the one end 27a. For example, a cathode terminal 45b of the second diode 45 is connected to an electric path between the other end 44b of the second capacitor 44 and the one end 41a of the first reactor 41, and an anode terminal 45a of the second diode 45 is connected to the one end 27a of the switching element 27.

The ZVS circuit 4 may further include a third diode 46 that allows current to flow from the other end 44b of the second capacitor 44 to the one end 42a of the first capacitor 42 and blocks current from the one end 42a of the first capacitor 42 to the other end 44b of the second capacitor 44. For example, the third diode 46 is located in series with the first reactor 41 between the one end 42a of the first capacitor 42 and the other end 44b of the second capacitor 44.

As an example, the third diode 46 is located between the other end 41b of the first reactor 41 and the one end 42a of the first capacitor 42. An anode terminal 46a of the third diode 46 is connected to the other end 41b of the first reactor 41, and a cathode terminal 46b of the third diode 46 is connected to the one end 42a of the first capacitor 42. That is, the other end 41b of the first reactor 41 is connected to the one end 42a of the first capacitor 42 via the third diode 46. The third diode 46 may be located between the other end 44b of the second capacitor 44 and the one end 41a of the first reactor 41.

A ZCS circuit 5 is a circuit that makes a transition of the switching element 27 from off to on to be soft switching. For example, the ZCS circuit 5 prevents increase of current of the switching element 27 (current from the one end 27a to the other end 27b) immediately after the switching element 27 is switched from off to on. As an example, the ZCS circuit 5 makes the transition of the switching element 27 from off to on to be zero current switching (ZCS). The term “ZCS” represents switching in which the current of the switching element 27 is substantially zero immediately after the switching element 27 is switched from off to on.

For example, a ZCS circuit 5 includes a second reactor 51 (an additional reactor). The second reactor 51 is located in series with the blocking diode 26 between the positive electrode of the load 9 and the one end 27a of the switching element 27. For example, the second reactor 51 is located between the one end 27a of the switching element 27 and the anode terminal 26a of the blocking diode 26.

A one end 51a of the second reactor 51 is connected to the one end 27a of the switching element 27, and another end 51b of the second reactor 51 is connected to the anode terminal 26a of the blocking diode 26. That is, the one end 27a of the switching element 27 is connected to the anode terminal 26a of the blocking diode 26 via the second reactor 51, and the other end 25b of the reactor 25 is also connected to the anode terminal 26a of the blocking diode 26 via the second reactor 51. The second reactor 51 may be located between the cathode terminal 26b of the blocking diode 26 and the one end 28a of the smoothing capacitor 28.

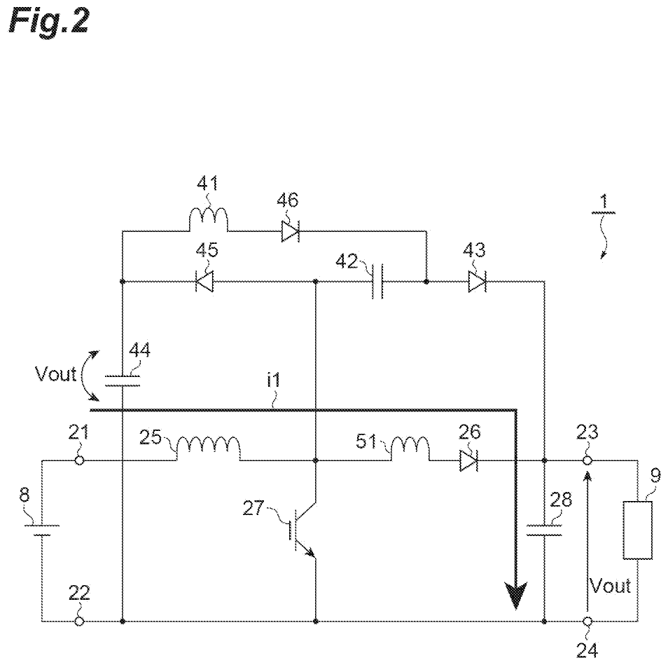

Hereinafter, with reference to FIGS. 2 to 6, the above-stated ZVS and ZCS will be described. FIG. 2 is a diagram illustrating the state of the DC-DC converter before the switching element is switched from off to on. In this state, a current i1 flows from the positive input terminal 21 to the smoothing capacitor 28 via the reactor 25, the second reactor 51, and the blocking diode 26. The voltage of the second capacitor 44 (potential difference between the other end 44b and the one end 44a) is substantially equal to the output voltage Vout.

When the switching element 27 is switched from off to on in the state of FIG. 2, the current i1 continues to flow to the second reactor 51 by the operation of the second reactor 51 immediately thereafter. Therefore, the current of the switching element 27 becomes substantially zero immediately after switching on. That is, the transition of the switching element 27 from off to on is ZCS.

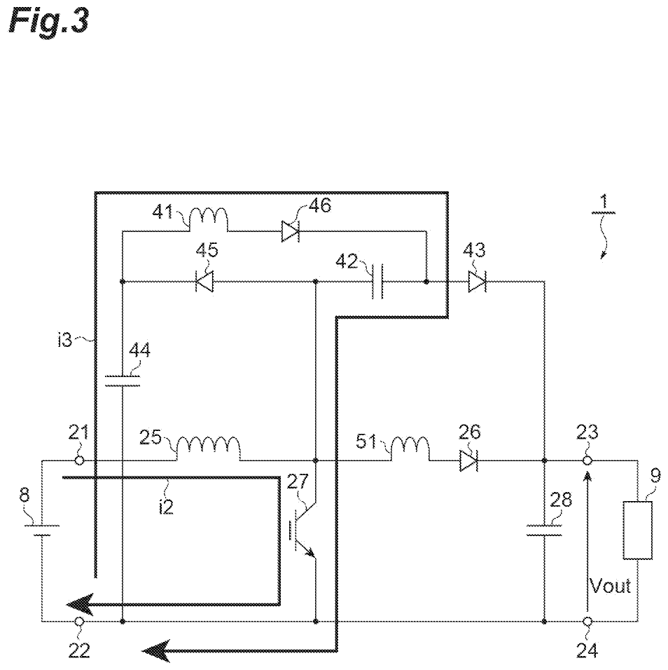

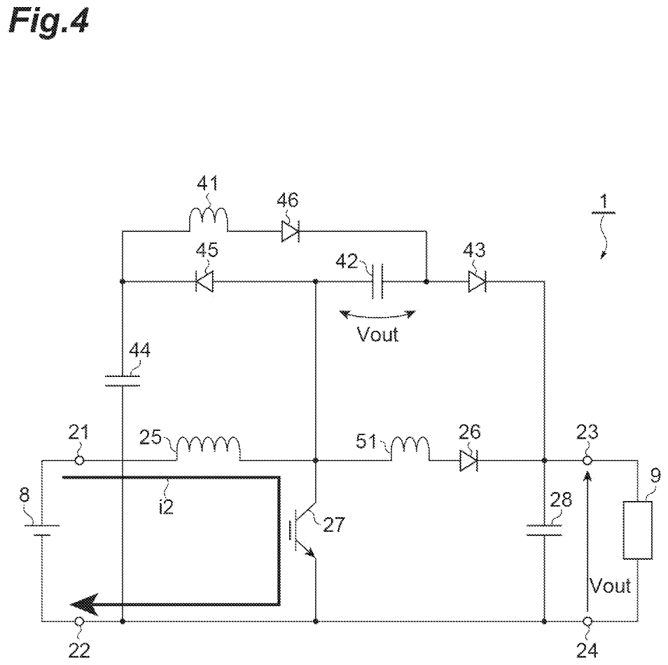

Thereafter, as illustrated in FIG. 3, currents i2 and i3 flow through the switching element 27. The current i2 flows from the positive input terminal 21 to the negative input terminal 22 via the reactor 25 and the switching element 27. Thus, the energy is accumulated in the reactor 25. The current i3 flows from the other end 44b of the second capacitor 44 to the one end 44a of the second capacitor 44 via the first reactor 41, the third diode 46, the first capacitor 42, and the switching element 27. As a result, the charge accumulated in the second capacitor 44 is transferred to the first capacitor 42, and the voltage of the first capacitor 42 is increased to the output voltage Vout as illustrated in FIG. 4.

When the switching element 27 is switched from on to off in the state of FIG. 4, the voltage of the first capacitor 42 continues to be equal to the output voltage Vout immediately after the switching. As a result, since the potentials at both ends of the switching element 27 (the one end 27a and the other end 27b) are equal to the potential of the negative output terminal 24, the voltage across the switching element 27 becomes substantially 0. That is, the transition of the switching element 27 from on to off is ZVS.

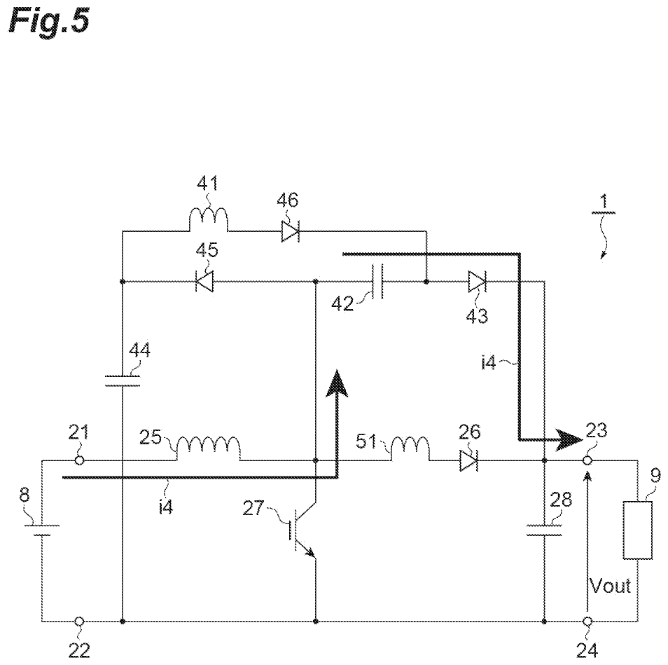

The energy accumulated in the reactor 25 during the period in which the switching element 27 is on is first accumulated in the smoothing capacitor 28 via the first capacitor 42 and the first diode 43. Accordingly, as illustrated in FIG. 5, a current i4 flows from the positive input terminal 21 to the smoothing capacitor 28 via the reactor 25, the first capacitor 42, and the first diode 43. When the discharge of the first capacitor 42 is completed, the voltage across the switching element 27 increases to the output voltage Vout. On the other hand, the energy of the reactor 25 is also accumulated in the smoothing capacitor 28 through the second reactor 51 and the blocking diode 26. Thus, the output voltage is boosted.

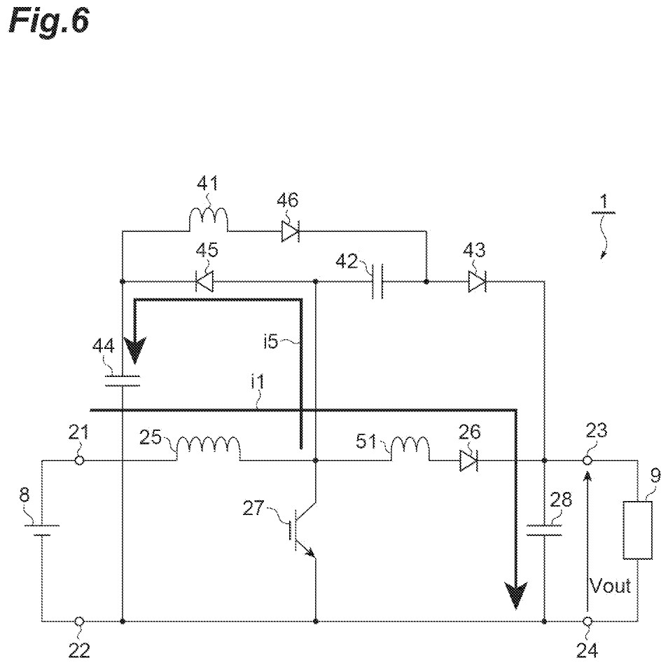

Further, as illustrated in FIG. 6, when the voltage across the switching element 27 increases and exceeds the voltage remaining in the second capacitor 44, a current i5 flows from the switching element 27 to the second capacitor 44 via the second diode 45. As described above, since the voltage across the switching element 27 increases to the output voltage Vout, the voltage of the second capacitor 44 also increases to Vout. As a result, the DC-DC converter 1 returns to the FIG. 2 state. The above operation is repeated at the switching cycle.

In order to make the transition of the switching element 27 from on to off to be ZVS, the voltage of the first capacitor 42 may be increased to the output voltage Vout before the switching element 27 is switched from on to off. Therefore, the capacitances of the first capacitor 42 and the second capacitor 44 may be set so as to satisfy the following conditions.

Condition 1) The capacitance of the second capacitor 44 is larger than the capacitance of the first capacitor 42.
Condition 2) Even if the control circuit 3 minimizes the off period of the switching element 27 in the above range, the voltage of the second capacitor 44 reaches the output voltage during the off period of the switching element 27.
Condition 3) Even if the control circuit 3 minimizes the on period of the switching element 27 in the above range, the voltage of the first capacitor 42 reaches the output voltage during the on period of the switching element 27.

The transition of the switching element 27 from on to off may not be ZVS. An increase in the voltage across the switching element 27 may be, at least, prevented immediately after the switching element 27 is switched from on to off. Therefore, the above Conditions 1 to 3 may not be satisfied.

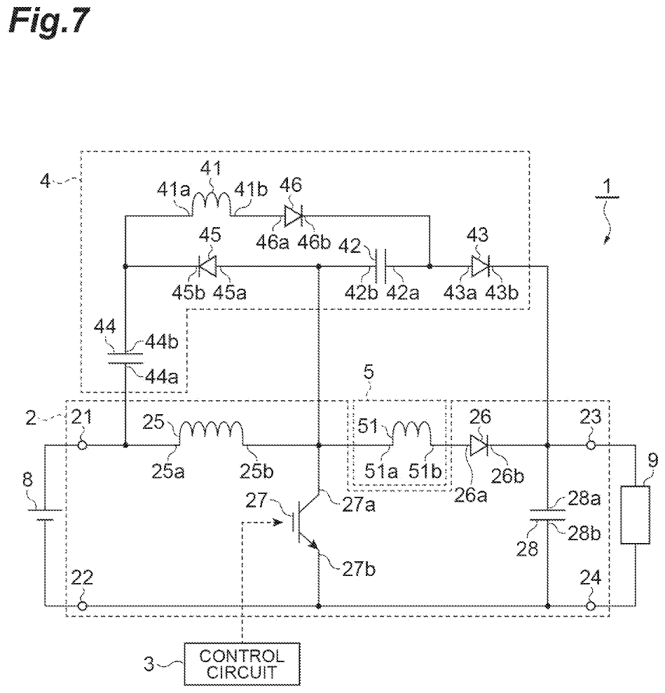

An example in which the first reactor 41 is located between the negative electrode of the DC power supply 8 and the one end 27a of the switching element 27, and the second capacitor 44 is located between the negative electrode of the DC power supply 8 and the first reactor 41 has been described, but the present disclosure is not limited thereto. As illustrated in FIG. 7, the first reactor 41 may be located between the positive electrode of the DC power supply 8 and the one end 27a of the switching element 27, and the second capacitor 44 may be located between the positive electrode of the DC power supply 8 and the first reactor 41. Also in this case, the condition for making the transition of the switching element 27 from on to off to be ZVS is the same as the above-described Conditions 1 to 3.

As described above, the DC-DC converter includes: the boost chopper circuit 2 including the reactor 25 located between the DC power supply 8 and the load 9, the blocking diode 26 located between the reactor 25 and the load 9, and the switching element 27 having the one end 27a connected between the reactor 25 and the blocking diode 9, the boost chopper circuit 2 boosting an input voltage from the DC power supply 8 to generate an output voltage to the load 9; a first reactor 41 located between the DC power supply 8 and the one end 27a of the switching element 27; the first capacitor 42 located between the first reactor 41 and the one end 27a of the switching element 27; the first diode 43 having the anode terminal 43a connected between the first reactor 41 and the first capacitor 42, and the cathode terminal 43b connected between the blocking diode 26 and the load 9; the second capacitor 44 located between the DC power supply 8 and the first reactor 41; and a second diode 45 having the cathode terminal 45b connected between the second capacitor 44 and the first reactor 41, and the anode terminal 45a connected to the one end 27a of the switching element 27.

In the DC-DC converter 1, when the switching element 27 is switched from on to off, increase of the potential of the one end 27a of the switching element 27 is delayed by the first reactor 41, the first capacitor 42, and the first diode 43. Thus, the power consumption when the switching element 27 is switched from on to off is reduced. Hereinafter, this effect is referred to as a “soft-off effect”. Here, if the difference between the input voltage and the output voltage is large, the voltage across the switching element 27 may not be sufficiently increased during the on period of the first capacitor 42, and the soft-off effect may not be sufficiently obtained. On the other hand, the DC-DC converter 1 further includes the second capacitor 44 located between the DC power supply 8 and the first reactor 41, and a second diode 45 having the cathode terminal 45b connected to the electric path between the second capacitor 44 and the first reactor 41 and the anode terminal 45a connected to the one end 27a of the switching element 27. According to this configuration, the charge corresponding to the output voltage is supplied to the second capacitor 44 during the off period of the switching element 27, and the charge is supplied from the second capacitor 44 to the first capacitor 42 during the on period of the switching element 27. Therefore, even when the difference between the input voltage and the output voltage is large, charges corresponding to the output voltage may be supplied to the first capacitor 42 and sufficiently increase the voltage of the first capacitor 42. Therefore, the DC-DC converter 1 may further reduce the switching loss.

The first reactor 41 may be located between the negative electrode of the DC power supply 8 and the one end 27a of the switching element 27, and the second capacitor 44 may be located between the negative electrode of the DC power supply 8 and the first reactor 41. The first reactor 41 may be located between the positive electrode of the DC power supply 8 and the one end 27a of the switching element 27, and the second capacitor 44 may be located between the positive electrode of the DC power supply 8 and the first reactor 41.

The capacitance of the second capacitor 44 may be greater than the capacitance of the first capacitor 42. In this case, the voltage of the first capacitor 42 can be more sufficiently increased during the on period of the switching element 27.

The capacitance of the second capacitor 44 may be set such that the voltage of the second capacitor 44 reaches the output voltage during the off period of the switching element 27, and the capacitance of the first capacitor 42 may be set such that the voltage of the first capacitor 42 reaches the output voltage during the on period of the switching element 27. In this case, the voltage of the first capacitor 42 can be more sufficiently increased during the on period of the switching element 27.

The DC-DC converter 1 may further include the third diode 46 located in series with the first reactor 41 between the first capacitor 42 and the second capacitor 44. In this case, reverse flow of charges from the first capacitor 42 to the first reactor 41 is prevented. Therefore, the voltage of the first capacitor 42 can be more sufficiently increased during the on period of the switching element 27.

The DC-DC converter 1 may further include the second reactor 51 located in series with the blocking diode 26 between the load 9 and the one end 27a of the switching element 27. In this case, when the switching element 27 is switched from off to on, the rise of the current flowing through the switching element 27 is delayed. This reduces power consumption when the switching element 27 is switched from off to on. Therefore, the switching loss can be further reduced.

As described above, the DC-DC converter 1 can greatly reduce the switching loss, thereby contributing to a reduction in size and cost by speeding up switching of a power factor correction (PFC) circuit for a single-phase input power supply, for example.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A DC-DC converter configured to perform DC-DC power conversion between a primary side and a secondary side, the DC-DC converter comprising:
a reactor;
a switching element configured to switch between an on period for accumulating a first energy in the reactor from the primary side and an off period for releasing the first energy from the reactor to the secondary side, causing a switch voltage acting on the switching element to rise during the off period;
a first capacitor electrically connected to the switching element; and
a second capacitor configured to:
accumulate a charge provided from the primary side during the off period; and
transfer the charge to the first capacitor during the on period, and
wherein the first capacitor is configured to suppress, using the charge transferred from the second capacitor, the rise of the switch voltage after the switching element is switched back to the off period.

2. The DC-DC converter according to claim 1, wherein the switching element comprises:
a first end electrically connected to a positive electrode of the primary side via the reactor; and
a second end electrically connected to a negative electrode of the primary side.

3. The DC-DC converter according to claim 2, further comprising a blocking diode configured to:
conduct a first current from the reactor to a positive electrode of the secondary side; and
block the first current from the positive electrode of the secondary side to the reactor.

4. The DC-DC converter according to claim 3, wherein the blocking diode is electrically connected between the first end and the positive electrode of the secondary side.

5. The DC-DC converter according to claim 4, further comprising a first additional reactor configured to conduct a second current from the second capacitor to the first capacitor to transfer the charge during the on period.

6. The DC-DC converter according to claim 5, further comprising a first diode configured to:
conduct a third current from the first capacitor to the positive electrode of the secondary side; and
block the third current from the positive electrode of the secondary side to the first capacitor.

7. The DC-DC converter according to claim 6, further comprising a second diode configured to:
conduct a fourth current from the first end to the second capacitor; and
block the fourth current from the second capacitor to the first end.

8. The DC-DC converter according to claim 7, further comprising a third diode configured to:
conduct the second current from the second capacitor to the first capacitor; and
block the second current from the first capacitor to the second capacitor.

9. The DC-DC converter according to claim 8, wherein the third diode is electrically connected between the first additional reactor and the first capacitor.

10. The DC-DC converter according to claim 8, wherein the third diode is electrically connected between the second capacitor and the first additional reactor.

11. The DC-DC converter according to claim 4, wherein the first capacitor is electrically connected between the first end and the second capacitor.

12. The DC-DC converter according to claim 11, wherein the second capacitor is electrically connected between the negative electrode of the primary side and the first capacitor.

13. The DC-DC converter according to claim 11, wherein the second capacitor is electrically connected between the positive electrode of the primary side and the first capacitor.

14. The DC-DC converter according to claim 5, wherein a capacitance of the second capacitor is greater than a capacitance of the first capacitor.

15. The DC-DC converter according to claim 5, wherein a secondary DC voltage is output to the secondary side by switching between the on period and the off period, and
wherein a voltage difference between an electrode of the second capacitor electrically connected to the first capacitor and the negative electrode of the primary side increases up to the secondary DC voltage during the off period.

16. The DC-DC converter according to claim 5, wherein a secondary DC voltage is output to the secondary side by switching between the on period and the off period, and
wherein a voltage difference between both electrodes of the first capacitor increases up to the secondary DC voltage during the on period.

17. The DC-DC converter according to claim 5, wherein the switching element causes a switch current flowing through the switching element to rise during the on period, and
wherein the DC-DC converter further comprises a second additional reactor configured to:
accumulate second energy during the off period; and
suppresses, using the second energy, the rise of the switch current after the switching element is switched to the on period.

18. The DC-DC converter according to claim 17, wherein the second additional reactor is further configured to conduct the first current from the first end to the positive electrode of the secondary side.

19. The DC-DC converter according to claim 18, wherein the second additional reactor is electrically connected between the first end and the blocking diode.

20. The DC-DC converter according to claim 18, wherein the second additional reactor is electrically connected between the blocking diode and the positive electrode of the secondary side.
